(19) United States
(12) Patent Application Publication
(10) Pub. No.: US 2005/0183517 A1
(43) Pub. Date: Aug. 25, 2005

(54) Strain gauge retaining assembly for vehicle seat

(75) Inventors: John Whitty, Bracebridge (CA); John T. Sickinger, Bracebridge (CA)

Correspondence Address: BANNER & WITCOFF LTD.,;ATTORNEYS FOR DURA AUTOMOTIVE, 28 STATE STREET - 28TH FLOOR, BOSTON, MA, 02109, US

(73) Assignee: DURA GLOBAL TECHNOLOGIES, INC., ROCHESTER HILLS, MI (US)

(21) Appl. No.: 10/786,246

(22) Filed: Feb. 25, 2004

(51) Int. Cl. G01L 1/26

(52) U.S. Cl. 73/862.391

(57) ABSTRACT

A strain gauge retaining assembly is used for occupant weight sensing in a vehicle seat and includes a bracket having an aperture extending therethrough. A strain gauge has a body portion and a mounting portion extending from the body portion, with the mounting portion extending through the aperture. A spring clip is positioned between the bracket and an engaging surface of the mounting portion, and resiliently biases the body portion into engagement with the bracket.

### FIELD OF THE INVENTION

This invention relates generally to a retaining assembly for a strain gauge, and, in particular, to a retaining assembly for a strain gauge used with a vehicle seat having improved fit, ease of assembly, and reliability.

### BACKGROUND OF THE INVENTION

Airbags are well known for use in vehicles to prevent and reduce injuries to the vehicle occupants. In many vehicles, if the weight of the occupant in a seat is less than a predetermined value, the airbag for that seat may be disabled. A strain gauge is typically used to determine the weight of the seat occupant. The strain gauge is typically secured to the seat assembly by way of a bracket or other support member. It is obviously important for the strain gauge to provide an accurate reading. In order to provide accurate, consistent and repeatable readings, the strain gauge should be securely anchored to the vehicle seat.

Some known strain gauge retaining assemblies consist of a body portion that houses the operable components of the gauge, and a mounting portion having a bolt and extending from the body through an aperture in a bracket. A retaining ring secured about the mounting portion secures the gauge to the bracket. Existing retaining assemblies for vehicle seat strain gauges are difficult to install, and require precise dimensioning in order to reduce tolerance variation and ensure good fit of the strain gauge. Known retaining assemblies may have excessive axial free play, resulting in reliability issues and excessive noise.

It is an object of the present invention to provide a strain gauge retaining assembly that reduces or overcomes some or all of the difficulties inherent in prior known devices. Particular objects and advantages of the invention will be apparent to those skilled in the art, that is, those who are knowledgeable or experienced in this field of technology, in view of the following disclosure of the invention and detailed description of certain preferred embodiments.

### SUMMARY

The principles of the invention may be used to advantage to provide a strain gauge retaining assembly with improved fit, ease of installation and reliability.

In accordance with a first aspect, a strain gauge retaining assembly is used for occupant weight sensing in a vehicle seat and includes a bracket having an aperture extending therethrough. A strain gauge has a body portion and a mounting portion extending from the body portion, with the mounting portion extending through the aperture. A spring clip is positioned between the bracket and an engaging surface of the mounting portion, and resiliently biases the body portion into engagement with the bracket.

In accordance with another aspect, a strain gauge retaining assembly used for occupant weight sensing in a vehicle seat includes a bracket having an aperture extending therethrough. A strain gauge includes a body, a shoulder, and a mounting bolt extending from the shoulder, with the shoulder and mounting bolt extending through the aperture. A spring clip has a substantially U-shaped recess defining a pair of opposed legs. A first surface of the spring clip engages the bracket, and an opposed second surface of the spring clip engages an engaging surface of the shoulder. The spring clip is compressed between the bracket and the engaging surface.

In accordance with a further aspect, a strain gauge retaining assembly used for occupant weight sensing in a vehicle seat includes a bracket having an aperture extending therethrough. A strain gauge includes a body, a shoulder having a groove formed therein, and a mounting bolt extending from the shoulder. The shoulder and mounting bolt extend through the aperture. A spring clip has a body portion, with the body portion having a substantially U-shaped recess defining a pair of opposed legs. The legs are received in the groove, with each leg having a leg ridge extending outwardly from a first surface of the leg. The body portion has a ridge extending outwardly from a first surface of the body portion. The leg ridges and the ridge of the body portion engage the bracket, and an opposed second surface of the spring clip engages a wall of the groove. The spring clip is compressed between the bracket and the wall of the groove.

Substantial advantage is achieved by providing a strain gauge retaining assembly in accordance with the present invention. In particular, such a strain gauge retaining assembly reduces the negative impact of tolerance buildup due to manufacturing variances, resulting in a strain gauge that is securely held to its mounting bracket, with reduced free play and noise. This is highly advantageous since the readings from the strain gauge will be more consistent and repeatable. The strain gauge retaining assembly is easy to assemble and disassemble, resulting in cost savings during manufacture, repair and/or replacement.

These and additional features and advantages of the invention disclosed here will be further understood from the following detailed disclosure of certain preferred embodiments.

### BRIEF DESCRIPTION OF THE DRAWINGS

FIG. 1 is a perspective view of a preferred embodiment of a strain gauge retaining assembly in accordance with the present invention.

FIG. 2 is a side elevation view of the strain gauge retaining assembly of FIG. 1.

FIG. 3 is a perspective view of the spring clip of the strain gauge retaining assembly of FIG. 1.

FIG. 4 is a front elevation view of the spring clip of the strain gauge retaining assembly of FIG. 1.

FIG. 5 is a perspective view of an alternative embodiment of the spring clip of a strain gauge retaining assembly in accordance with the present invention.

FIG. 6 is a side elevation view of the spring clip of FIG. 5, shown in its installed condition in a strain gauge retaining assembly.

The figures referred to above are not drawn necessarily to scale and should be understood to provide a representation of the invention, illustrative of the principles involved. Some features of the strain gauge retaining assembly depicted in the drawings have been enlarged or distorted relative to others to facilitate explanation and understanding. The same reference numbers are used in the drawings for similar or identical components and features shown in various alternative embodiments. Strain gauge retaining assemblies as disclosed herein would have configurations and components determined, in part, by the intended application and environment in which they are used.

### DETAILED DESCRIPTION OF CERTAIN PREFERRED EMBODIMENTS

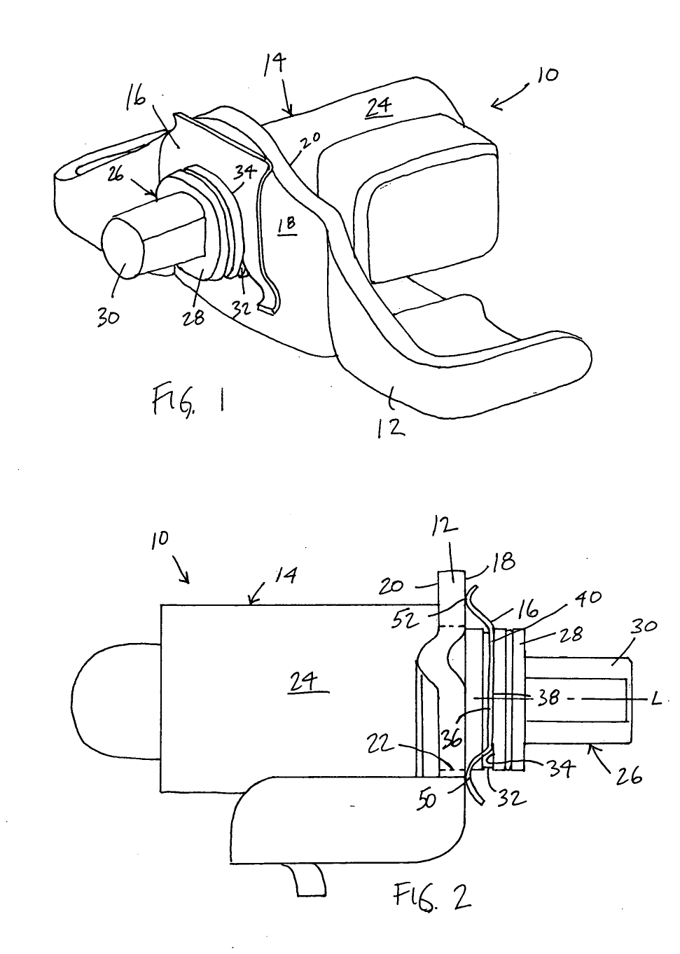

The present invention may be embodied in various forms. A strain gauge retaining assembly is typically attached to a vehicle seat for use in determining the weight of the seat occupant. A preferred embodiment of a strain gauge retaining assembly 10 is shown in FIGS. 1-2. Strain gauge retaining assembly 10 includes a bracket 12, a strain gauge 14, and a spring clip 16. Bracket 12 includes a first surface 18 and an opposed second surface 20, with an aperture 22 extending through bracket 12 from first surface 18 to second surface 20. Bracket 12 is secured to a vehicle seat assembly (not shown) in known fashion.

Strain gauge 14 is operably connected to the vehicle seat in known fashion (not shown) in order to detect the weight of the seat occupant. Further discussion of the operation of strain gauge 14 need not be provided here. Strain gauge 14 includes a body 24 and a mounting portion 26. Mounting portion 26 extends through aperture 22, with body 24 abutting second surface 20 of bracket 12. In the illustrated embodiment, mounting portion 26 includes a shoulder 28 positioned adjacent body 24 and a mounting bolt 30 extending outwardly from shoulder 28.

A groove 32 is formed in shoulder 28 and defines an engagement surface 34 configured to engage spring clip 16. In a preferred embodiment, surface 34 extends substantially perpendicular to a longitudinal axis L of mounting bolt 30. In a preferred embodiment, groove 32 is a circumferential groove extending about the exterior surface of shoulder 28, and engagement surface 34 is a wall of groove 32. It is to be appreciated that surface 34 can be provided in many different ways. For example, a projection could be formed on mounting portion 26 in order to provide an engagement surface for engagement with spring clip 16.

Spring clip 16 is positioned into resilient engagement between shoulder 28 and bracket 12. Specifically, a first surface 36 of spring clip 16 resiliently engages first surface 18 of bracket 12 and an opposed second surface 38 of spring clip 16 resiliently engages surface 34 of shoulder 28, biasing surface 34 away from first surface 18 of bracket 12. Consequently, body 24 is biased into abutting engagement with second surface 20 of bracket 12, ensuring that strain gauge 14 is securely anchored to bracket 12. This axial biasing force reduces free play between strain gauge 14 and bracket 12, improving the reliability of strain gauge 14 and reducing noise.

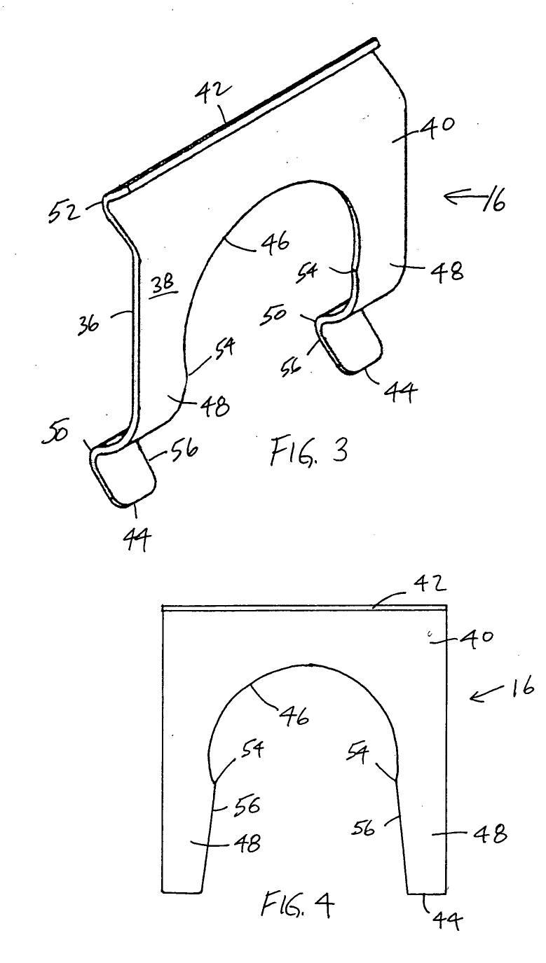

A preferred embodiment of spring clip 16 is shown in FIGS. 3-4. Spring clip 16 comprises a body portion 40 with a first end 42 and a second end 44. Body portion 40 has a substantially U-shaped recess 46 that defines a pair of opposed legs 48 extending away from first end 42 and toward second end 44. A projection, illustrated here as a leg ridge 50, is formed in each leg 48 proximate second end 44. A projection, illustrated here as a ridge 52, is similarly formed in body portion 40 proximate first end 42. The projections 50, 52 serve to engage first surface 18 of bracket 12, as spring clip 16 is compressed in its installed condition. In the illustrated embodiment, leg ridge 50 is formed by bending a portion of leg 48 outwardly away from first surface 36 and then back toward first surface 36, and extends across leg 48. Ridge 52 is similarly formed by bending a portion of body portion 40 outwardly from first surface 36 and then back toward first surface 36, and extends across body portion 40. Other methods of forming a suitable projection or ridge will become readily apparent to those skilled in the art, given the benefit of this disclosure.

In order to place spring clip 16 in position, ridges 50, 52 and first surface 36 of spring clip 16 face bracket 12, and second surface 38 of spring clip 16 faces outwardly from bracket 12. Spring clip 16 is then passed over shoulder 28 with a leg 48 on each side of shoulder 28. Ridges 50, 52 engage first surface 18 of bracket 12 and second surface 38 of legs 48 of spring clip 16 engage surface 34 of groove 32. The distance between first surface 18 of bracket 12 and surface 34 of groove 32 is slightly smaller than the thickness of spring clip 16, which is measured from second surface 38 of body portion 40 to first surface 36 of ridges 50, 52. Thus, spring clip 16 is slightly compressed when it is received in groove 32, creating an axial force along longitudinal axis L that keeps body 24 of strain gauge 14 tight against second surface 20 of bracket 12. As noted above, this tight fit reduces any free play between strain gauge 14 and bracket 12.

In a preferred embodiment, as seen in FIG. 4, recess 46 has a necked portion 54, which is a slightly narrowed portion of the substantially U-shaped recess. Necked portion 54 has a width that is slightly less than the diameter of shoulder 28 measured at the base of groove 32. Thus, spring clip 16 is snap-fit into engagement with groove 32. This helps to ensure that spring clip 16 is retained on shoulder 28. However, spring clip 16 can be removed from shoulder 28 by grasping and pulling spring clip radially away from shoulder 28.

In a preferred embodiment, as seen in FIG. 4, legs 48 may be tapered toward second ends 44. As illustrated here, the inner edge 56 of each leg 48 along recess 46 is tapered from necked portion 54 to second end 44. Thus, recess 46 is slightly wider at second end 44, allowing for easy insertion of spring clip 16 into groove 32.

Spring clip 16 can be formed of many different materials including, for example, spring steel or stainless steel. Spring clip 16 is preferably formed of a material with enough resilience to exert sufficient force and deflection when installed in strain gauge retaining assembly 10 without permanent deformation. Other suitable materials for spring clip 16 will become readily apparent to those skilled in the art, given the benefit of this disclosure.

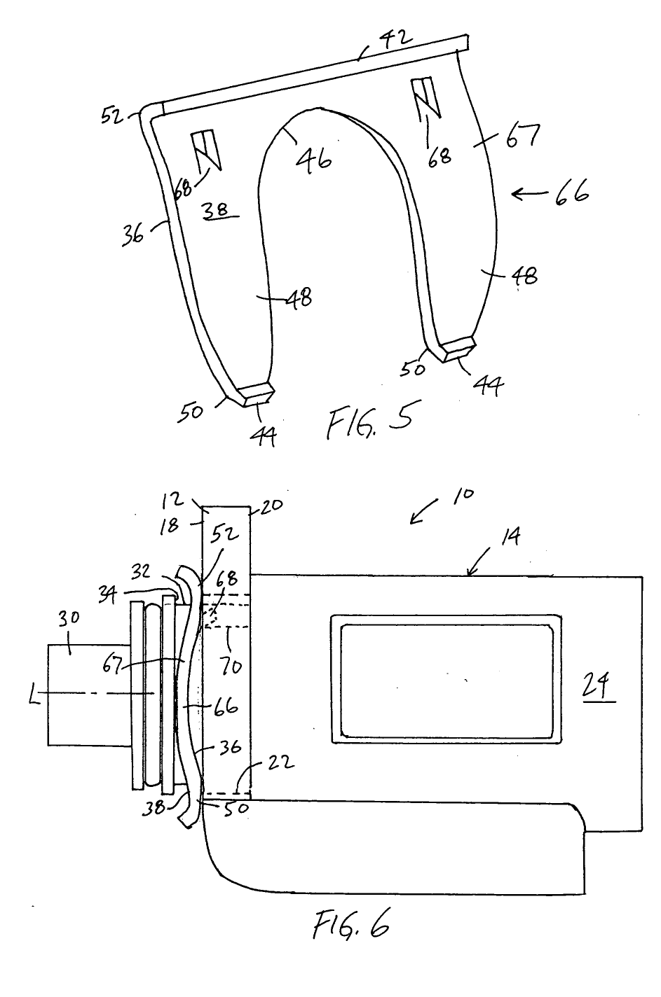

Another preferred embodiment of a spring clip 66 is shown in FIG. 5. Spring clip 66 has a body portion 67 that includes a pair of tabs 68 extending outwardly from first surface 36. As can be seen in FIG. 6, each tab 68 is received in a recess 70 formed in bracket 12. In the illustrated embodiment, recess 70 is an aperture extending through bracket 12, however, it is to be appreciated that recess 70 need only be deep enough to receive a tab 68. By forming recess 70 as an aperture, a tool (not shown) may be inserted through the aperture to release tab 68 from engagement with recess 70, allowing spring clip 66 to be removed.

The engagement of each tab 68 with a respective recess 70 serves to prevent rotation of spring clip 66 with respect to bracket 12 and to retain spring clip 66 on bracket 12. It is to be appreciated that body portion may include a single tab 68 and mating recess 70, or more than two mating tabs and apertures. In a preferred embodiment, tab 68 is formed by slitting body portion 67 and bending tab 68 away from first surface 36. In the embodiment illustrated in FIGS. 5-6, body portion 67 is curved inwardly toward first surface 36.

In light of the foregoing disclosure of the invention and description of the preferred embodiments, those skilled in this area of technology will readily understand that various modifications and adaptations can be made without departing from the scope and spirit of the invention. All such modifications and adaptations are intended to be covered by the following claims.

1. A strain gauge retaining assembly used for occupant weight sensing in a vehicle seat comprising, in combination:
a bracket having an aperture extending therethrough;
a strain gauge having a body and a mounting portion extending from the body, the mounting portion extending through the aperture;
a spring clip positioned between the bracket and an engaging surface of the mounting portion, the spring clip resiliently biasing the body into engagement with the bracket.

2. The strain gauge retaining assembly of claim 1, wherein a groove is formed on an exterior surface of the mounting portion and receives the spring clip.

3. The strain gauge retaining assembly of claim 1, wherein the spring clip comprises:
a body portion having a first surface and an opposed second surface, a first end and a second end;
a substantially U-shaped recess formed in the body portion and defining a pair of opposed legs, each leg extending away from the first end toward the second end and having a projection extending outwardly from its first surface proximate the second end; and
a projection extending outwardly from the first surface of the body portion proximate the first end.

4. The strain gauge retaining assembly of claim 3, wherein the projection of each leg is a ridge extending across the leg and the projection of the body portion is a ridge extending across the body portion.

5. The strain gauge retaining assembly of claim 4, wherein the ridge of each leg and the ridge of the body portion engage the bracket, and the second surface of the body portion engages a groove formed in an exterior surface of the mounting portion.

6. The strain gauge retaining assembly of claim 3, wherein the substantially U-shaped recess includes a necked region.

7. The strain gauge retaining assembly of claim 6, wherein the width of the necked region is slightly smaller than a diameter of the mounting portion at a base of the engaging surface.

8. The strain gauge retaining assembly of claim 3, wherein at least a portion of each leg is tapered toward the second end such that the substantially U-shaped recess is widest at its open end.

9. The strain gauge retaining assembly of claim 1, wherein the engaging surface of the mounting portion is a wall of a groove formed in the mounting portion.

10. The strain gauge retaining assembly of claim 1, wherein the mounting portion includes a shoulder and a bolt.

11. The strain gauge retaining assembly of claim 1, wherein the spring clip is curved inwardly toward a first surface thereof.

12. The strain gauge retaining assembly of claim 1, wherein the spring clip includes at least one tab extending outwardly from a surface of the spring clip, and the bracket includes at least one recess, each recess receiving a corresponding tab.

13. A strain gauge retaining assembly used for occupant weight sensing in a vehicle seat comprising, in combination:
a bracket having an aperture extending therethrough;
a strain gauge comprising:
a body;
a shoulder; and
a mounting bolt extending from the shoulder, the shoulder and mounting bolt extending through the aperture; and
a spring clip having a substantially U-shaped recess defining a pair of opposed legs, a first surface of the spring clip engaging the bracket and an opposed second surface of the spring clip engaging an engaging surface of the shoulder, the spring clip being compressed between the bracket and the engaging surface.

14. The strain gauge retaining assembly of claim 13, wherein the shoulder includes a groove formed therein, a wall of the groove forming the engaging surface of the shoulder.

15. The strain gauge retaining assembly of claim 13, wherein each leg has a projection extending outwardly from its first surface and the body portion has a projection extending outwardly from its first surface, the projections engaging the bracket.

16. The strain gauge retaining assembly of claim 15, wherein the projection of each leg is a ridge extending across the leg and the projection of the body portion is a ridge extending across the body portion.

17. The strain gauge retaining assembly of claim 13, wherein the substantially U-shaped recess includes a necked region.

18. The strain gauge retaining assembly of claim 13, wherein at least a portion of each leg is tapered toward an end thereof such that the substantially U-shaped recess is widest at its open end.

19. A strain gauge retaining assembly used for occupant weight sensing in a vehicle seat comprising, in combination:
a bracket having an aperture extending therethrough;
a strain gauge comprising:
a body;
a shoulder having a groove formed therein; and
a mounting bolt extending from the shoulder, the shoulder and mounting bolt extending through the aperture; and
a spring clip having a body portion, the body portion having a substantially U-shaped recess defining a pair of opposed legs, the legs being received in the groove, each leg having a leg ridge extending outwardly from a first surface of the leg, the body portion having a ridge extending outwardly from a first surface of the body portion, the leg ridges and the ridge of the body portion engaging the bracket and an opposed second surface of the spring clip engaging a wall of the groove, the spring clip being compressed between the bracket and the wall of the groove.

20. The strain gauge retaining assembly of claim 19, wherein the substantially U-shaped recess includes a necked portion.

21. The strain gauge retaining assembly of claim 20, wherein the width of the necked region is slightly smaller than a diameter of the shoulder at a base of the groove.

22. The strain gauge retaining assembly of claim 19, wherein at least a portion of each leg is tapered toward its end such that the substantially U-shaped recess is widest at its open end.
